(19) United States
(12) Patent Application Publication
(10) Pub. No.: US 2007/0069480 A1
(43) Pub. Date: Mar. 29, 2007

(54) Sealing element for arranging between a motor vehicle steering column cover and a lining part, arrangement consisting of a sealing element and a lining part, and method for mounting the sealing element on a lining part

(76) Inventor: Albert Brandstätter, Odelzhausen (DE)

Correspondence Address: Viering Jentschura & Partner, Suite 203, 3770 Highland Avenue, Manhattan Beach, CA, 90266, US

(21) Appl. No.: 10/577,581

(22) PCT Filed: Oct. 22, 2004
(86) PCT No.: PCT/EP04/11962

§ 371 Date: Apr. 27, 2006

(30) Foreign Application Priority Data
Oct. 27, 2003 (DE) 103 49 681.5

(51) Int. Cl. F16J 15/14

(52) U.S. Cl. 277/590

(57) ABSTRACT

The invention relates to a sealing element (1) for arranging between a lining part (3) and a steering column cover (5) of a steering axle, said sealing element being characterised in that it is formed from a foamed part (10) consisting of a restorable material and comprising two limbs (11a, 11b) and a curved, annular, or toroidal central part (11c) connecting the same, or being embodied in an annular or toroidal manner. The invention also relates to methods for mounting said sealing element on a lining part (3).

This application is based on PCT/EP2004/011962 claiming priority of German patent application DE 103 49 681.5 having a filing date of Oct. 27, 2003, the entire content of which is herewith incorporated by reference.

### BACKGROUND OF THE INVENTION

The invention relates to a sealing arrangement to be arranged between a motor vehicle steering column cover and a lining part, to an arrangement comprising a sealing element and a lining part, and to a method for mounting the sealing element on a lining part. The sealing element or arrangement is intended in particular to interact with an adjustable motor vehicle steering column.

Steering columns of motor vehicles extend from the vehicle interior toward the steering mechanism and project through an opening in the dashboard or an interior lining part in particular in the region of the driver's legs. In particular in the region of the motor vehicle interior, steering columns are partially surrounded by a lining. This steering column lining part or steering column cover extends as far as the interior lining part and typically also through the opening provided therein.

In the case of steering columns which can be adjusted transversely with respect to the steering column axis, the size and shape of the opening in the lining part are formed to match the intended adjustment options for the steering column as well as the shape of the steering column cover, so that in every adjustment position of the steering column a residual opening or a hatch or gap remains beneath the steering column, out of sight of the driver. Therefore, the shape and size of this hatch or gap is likewise dependent on the adjustment position of the steering column.

It is known from the prior art for the remaining opening or the gap simply not to be covered or to be covered by means of a louvered textile fabric or plastic bars essentially for visual reasons.

DE 43 37 721 C1 has disclosed a gap cover at an adjustable steering column of a motor vehicle which is formed from a flexible covering element for the variable gap between the steering column or a lining part connected to it and an opposite part of a dashboard. The covering element is curved approximately in a S shape in a longitudinal section corresponding to a center position of the steering column and therefore forms a loop which, in the region adjoining the lining part, is curved concavely toward the vehicle driver. For this purpose, the end regions of the covering element, in the axial direction of the steering column, are secured to the respectively associated components running approximately in opposite directions. The end regions of the covering element, which are oriented approximately oppositely to the axis of the steering column, are secured on the one hand to the lining part and on the other hand to the housing, which is releasably connected to the dashboard. The securing to the lining part of the steering column is provided with a bracket and a clip connection. In the event of an axial movement of the steering column, a large part of the gap cover curves outward or inward in a undetermined way, which is disadvantageous.

DE 103 49 681 C2 has disclosed a covering part to be arranged between a lining part and a steering column cover of a steering shaft, which has a plurality of annular supporting parts which are spaced apart from one another in the axial direction, are formed from a dimensionally stable plastic and are in each case connected by an elastic connection. On the outer side, the covering part is laminated to a stretchable film in order to improve its appearance.

### SUMMARY OF THE INVENTION

It is an object of the invention to provide a sealing element which acts between lining part and steering column, is arranged in a stable manner in any adjustment position between the interior lining part and the steering column cover and improves interior comfort.

A further object of the invention is to provide a method which allows economic production and fitting of the sealing element according to the invention in large numbers, with the sealing element being sufficiently well secured to the corresponding lining part for it to be able to withstand even a very high assumed number of actuations of an adjustable steering column during use without being damaged.

These objects are achieved by the independent patent claims. Further embodiments are specified in the subclaims which respectively refer back to the latter.

The invention provides a sealing element to be arranged between a lining part and a steering column cover of a steering shaft, which sealing element has a foam part made from a resilient material and is formed with two limbs and a curved center part connecting them.

The invention provides a sealing element to be arranged between a lining part and a steering column cover of a steering shaft, which sealing element has a foam part made from a resilient material and is formed in the shape of a torus and/or a rim.

The sealing element may be formed in two layers from the resilient foam part and in addition, on the side facing the steering column cover, at least in sections, additionally from a layer of material with sliding properties. The layer of material with sliding properties can be laminated on, adhesively bonded on or applied to the foam part by flocking. Alternatively, the layer of material with sliding properties may be formed from a covering part made from flexible and stretchable material. The covering part may, at least in sections, be stretched over the foam part and/or fixed on the lining part by means of securing means. The covering part may be adhesively bonded to the lining part in punctiform fashion or in regions. As an alternative or in addition, the covering part may be welded to the lining part in punctiform fashion or in regions.

The covering part may also be formed as a flexible tube or hose in the shape of the sealing element to be produced, in which case foam is foamed into the flexible tube or hose to form the sealing element.

The covering part may be formed in a single layer from a polyamide fabric.

Alternatively, the covering part may be formed in two layers from a polyamide fabric and a foam layer, the foam layer being arranged on the side of the foam part.

It is also possible for the covering part to be formed in three layers from two polyamide fabric layers and a foam layer positioned between them.

The material used for the foam part may be a material which satisfies one or more of the following determining variables:
material density preferably 24 kg/m³ with a deviation of ±0.25;
compression hardness at 40% deformation: between 0.5 and 3 kPa;
foam material cell count between 20 and 200 per cm.

The foam part may be formed from polyether or polyurethane.

The invention also provides an arrangement between a lining part and a steering column cover having a sealing element arranged between them, the sealing element, as seen in a section plane in which the steering center axis lies and which passes through the middle third of the sealing element, being positioned in such a manner with respect to the steering column cover and the lining part that the extension, projected onto the section plane, of the contour lines of the edge region of the lining part or of the section lines in the section plane lies inside the cross section of the sealing element.

In the arrangement comprising a sealing element, the sealing element may be fitted on a frame element. Furthermore, a Teflon layer may be arranged on the region of the steering column cover which is intended to bear against the sealing element.

The invention also proposes a method for mounting a sealing element between a lining part and a steering column cover, comprising the following steps:
positioning the lining part on the top side of a receiving apparatus,
placing a prefabricated starting material on the lining part to form the covering part,
fixing the covering part to the lining part by way of a first edge region,
fixing a second edge region of the prefabricated covering part to the lining part by means of clips.

In the method according to the invention, the fixing of the covering part by way of a first edge region can be effected by adhesive bonding or welding or by means of securing elements. As an alternative or in addition, the fixing of the covering part by way of the second edge region may be effected by adhesive bonding or welding or by means of securing elements.

The foam part may be secured to the covering part and/or to the lining part. The welding or adhesive bonding may be effected in punctiform fashion or over areal regions.

One advantage of the sealing element according to the invention is that if an adjustable steering column is used, the force required to adjust the latter is relatively low.

A further advantage of the invention is that the sliding layer results in a very durable sealing element in operational use.

The sealing element 1 according to the invention is also advantageous if the steering column is not adjustable, since the positional stability of the sealing element is ensured even in the event of the parts between which the sealing element is arranged vibrating.

The use of the sealing element according to the invention results in efficient sealing of the interior with respect to noise and dirt from the chassis region.

### BRIEF DESCRIPTION OF THE DRAWINGS

In the text which follows, the inventions are described with reference to the appended figures, in which:

FIG. 1 diagrammatically depicts an excerpt from the lining part and the steering column cover, as well as the sealing element arranged between them, as seen from the side,

FIG. 2 diagrammatically depicts an excerpt from the combination of lining part, steering column cover and sealing element arranged between them as seen from the vehicle interior, without illustrating a steering column shaft, so that a corresponding opening in the steering column cover can be seen,

FIG. 3 shows a view of an embodiment of a cut piece of foam used for the sealing element according to the invention, on its own as seen obliquely from the front;

FIG. 4a shows an end piece of a variant of the cut piece of foam as seen obliquely from the front, suitable for positively locking fitting into a frame element that is to be used for the lining part,

FIG. 4b shows a frame element for receiving the cut piece of foam from FIG. 4a, which may be formed integrally with the lining part or as a separate part,

FIG. 4c shows an end piece of the combination of the sealing element with the frame element from FIG. 4b, with the covering part according to the invention laminated onto the cut piece of foam,

FIG. 5a shows a further embodiment of the sealing element, in a form which is continuous in the peripheral direction,

FIG. 5b shows a further embodiment of the sealing element, formed in two parts, in a form which is continuous in the peripheral direction,

FIG. 5c shows a further embodiment of the sealing element, in a form which is continuous in the peripheral direction,

FIG. 6 shows an excerpt from a further embodiment of the sealing element for use with or without a frame element, in which the covering part is stretched over the cut piece of foam, as seen from the interior of the lining part in the direction of the vehicle interior,

FIG. 7 shows the embodiment of the sealing element from FIG. 6 in the form of a lateral section on line 2-2 in FIG. 6, illustrating the opening edge of the lining part which interacts with the sealing element and also the steering column cover, the latter being shown in a reference position and also in two further positions by dashed lines,

FIG. 8 shows a cross section through the covering part for use for a sealing element as shown in FIG. 6,

FIG. 9a, to illustrate a step of the mounting of the sealing element on a lining part in accordance with the invention, shows the lining part, fitted on a receiving apparatus, with a covering part fixed to it, in the prefabricated state,

FIG. 9b illustrates a further step of the mounting of the sealing element on a lining part, in which, starting from the step shown in FIG. 9a, a cut piece of foam is laid onto the lining part,

FIG. 9c illustrates a further step of the mounting of the sealing element on a lining part, in which the cut piece of foam is welded to the lining part at predetermined points, although this step may also be carried out in alternative ways,

FIG. 9d illustrates a further mounting step, in which the covering part is stretched over the cut piece of foam on that side of the lining part which faces away from the vehicle interior and, in an alternative, is welded to the lining part at predetermined points.

### DETAILED DESCRIPTION OF THE DRAWINGS

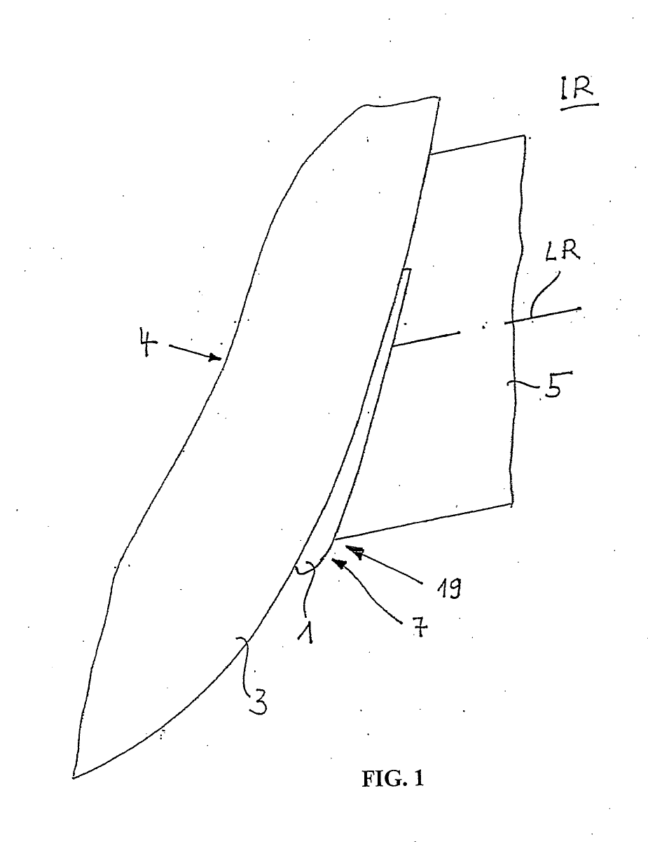

The sealing element 1 illustrated in FIGS. 1 to 8 is intended to seal off a gap 7 which is present between a lining part 3 of a motor vehicle and a steering column cover 5 projecting through it. The lining part 3 may in particular be a dashboard, for example an upper part or lining part, e.g. a lower lining part of a dashboard. The lining part is in general terms a component in the interior of a motor vehicle through which a steering column passes in respect of its cross section. The gap 7 is part of an opening 4 through which the steering column extends. The lining part 3 is part of the inner lining in the region of the dashboard (not shown) in the interior IR of a motor vehicle and is located in the region of the driver's legs. The sealing by means of the sealing element 1 also has the function of sound insulation with respect to noise from the engine compartment, and of covering the gap 7.

The side view, shown in FIG. 1, of an embodiment of the sealing element 1 arranged between the lining part 3 and the steering column cover 5 shows a specific position of the sealing element 1 between the abovementioned lining parts 3 and 5, in which the sealing element 1 projects a certain amount out of the lining part 3. Given appropriate shaping of the lining part 3. With a suitable shaping of the lining part 3, it is possible for the sealing element 1 to be set further back in the lining part 3.

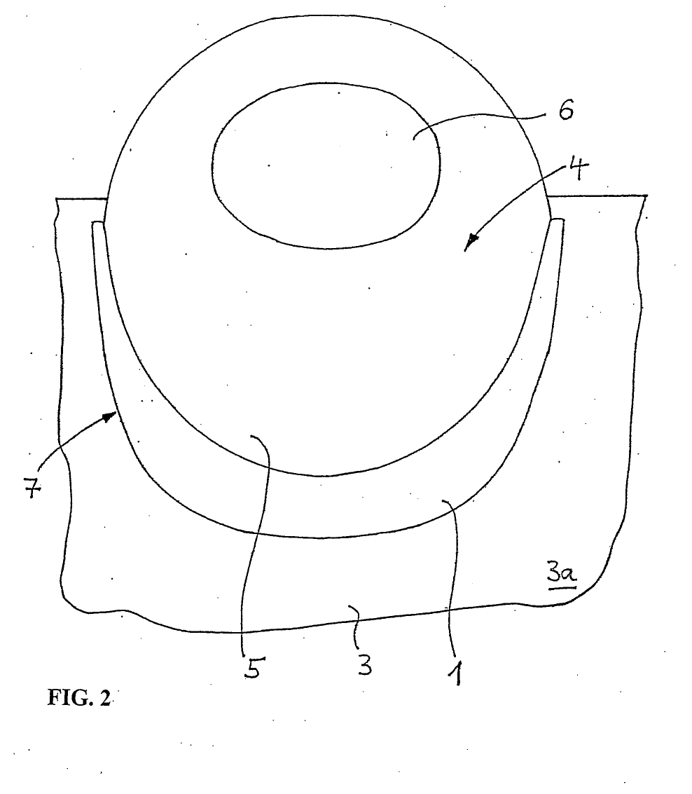

FIG. 2 diagrammatically depicts an excerpt from the combination of the lining part 3, the steering column cover 5 and an embodiment of the sealing element 1 arranged between them, as seen from the vehicle interior IR, specifically approximately from the driver's viewpoint. When seen from this direction, the interior side 3a of the lining part 3 is visible. The steering column cover 5 illustrated has an opening 6 through which the shaft (not illustrated in FIG. 2) of the steering column extends. The steering column is preferably adjustable in the longitudinal direction LR of the steering column shaft or in the direction of the steering center axis LR. However, the sealing element 1 according to the invention can also be used if, as an alternative or in addition, the steering column is adjustable transversely with respect to its longitudinal axis, i.e. is height-adjustable, or is pivotable with respect to a reference point lying in the region of the steering mechanism. Optional adjustment mechanisms of this type are not illustrated in the figures.

The sealing element 1 is formed from a foam part or a cut piece of foam 10 and, depending on the particular application, optionally also a layer of material with sliding properties, which serves as a sliding layer with respect to the edge region 19 of the steering column cover 5. This layer may be realized by a covering part 20. Alternatively, the layer of material with sliding properties may be laminated or adhesively bonded onto the foam part or the cut piece of foam 10 or may be applied to the foam part 10 by flocking. In the arrangement of the sealing element 1 between the lining part 3 and the steering column cover 5, the layer of material with sliding properties is arranged on the side which faces the steering column cover 5. The layer of material with sliding properties, and in particular the covering part, may be dispensed with in particular if the steering column is adjustable only transversely with respect to the steering shaft but not in the longitudinal direction of the steering shaft.

In an alternative embodiment of the invention, the further layer of material with sliding properties, which is arranged at least in sections on the cut piece of foam, is in sections flocked with particles of textile materials. The flocking with textile particles maintains the mobility of the sealing element, and at the same time the coating produced by flocking with textile particles is robust or resistant to wear caused by relative movements between the cover 5 and the lining part 3. The flocking is preferably achieved by first of all applying adhesive to the region of the sealing element which is to be flocked, for example by spraying the sealing element surface, and then covering the surface which has been provided with adhesive with textile particles. A suitable adhesive is a curable pressure-sensitive adhesive. The flocking with textile particles can also be produced by dipping at least part of the sealing element in a corresponding bath containing textile particles. The flocking of the cut piece of foam results in a velvety feel and good sliding properties.

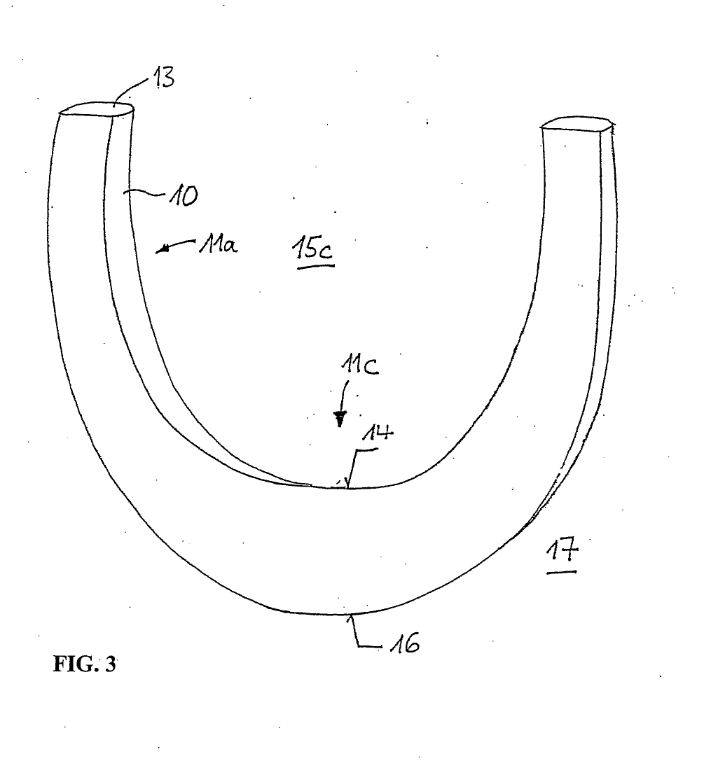

One embodiment of the cut piece of foam 10 is shown, on its own and as seen obliquely from the front, in FIG. 3. This is in a form in which corresponding surfaces of the cut piece of foam can be brought to bear on the one hand against an edge region of the lining part and on the other hand against a bearing surface of the steering column cover, in order to seal off an opening that is present between the lining part and the steering column cover at least in regions. It is preferable for the sealing element 1 overall to be curved in form. In particular, the sealing element 1 may preferably be formed as a single piece with two limbs 11a, 11b and a curved center part 11c connecting them, and in a preferred embodiment may substantially have a curved, in particular U-shaped or horseshoe-shaped form (FIG. 3).

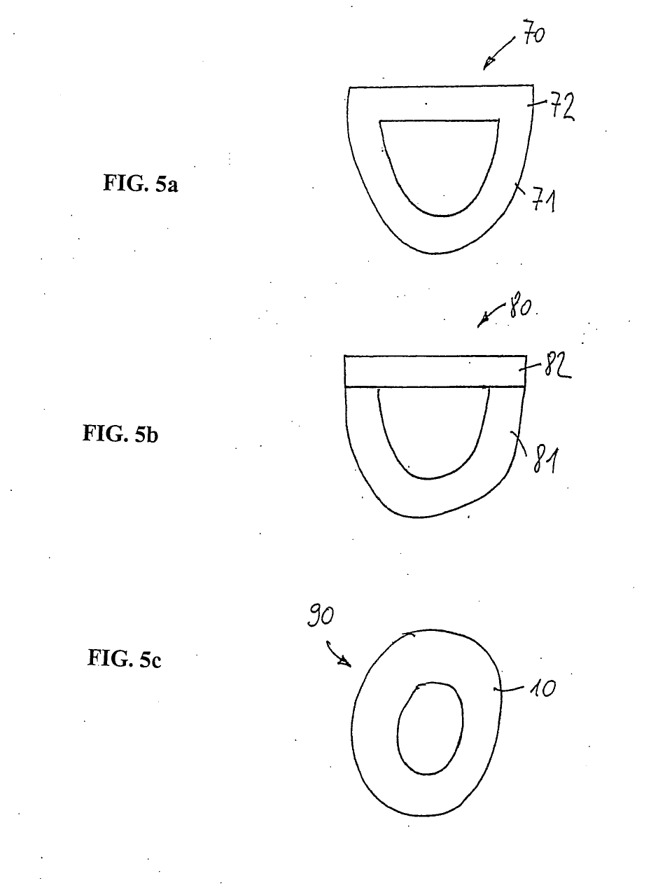

The sealing element may also be in a form which is continuous in the peripheral direction and in particular in a collar, torus or ring form, i.e. such that it surrounds or engages around the steering column cover (FIGS. 5a, 5b, 5c). The shape and size of the cut surface may be variable or constant at least in sections as seen in the peripheral direction. In all alternatives, the sealing element may be formed as a single piece (FIGS. 5a and 5c, reference numerals 70 and 90) or as more than one piece (FIG. 5b, reference numeral 80).

In the case of the multi-piece embodiment of the sealing element, the latter may in particular be formed in two pieces. In this case, the region which is intended to be arranged at the region of the dashboard may be provided to bear against the region of the dashboard. It is also possible for at least part of this region to be realized by the mirror panel of the dashboard region. In particular in this application, but also in general terms, the sealing element may be formed from a curved, in particular U-shaped region 71 or 81 and a transverse part 72 or 82, which connects the ends of the curved part 71 or 81 to one another by bearing against both ends of the curved part 71 or 81. In the case of the two-piece construction as shown in FIG. 5b, the transverse part may be adhesively bonded to the ends of the curved part 71 or 81. In addition or as an alternative, the transverse part may be plug-fitted onto the ends of the curved part 71 or 81.

One advantage of the two-piece configuration of the sealing element is that it can be fitted to the steering column cover even after the steering column has been mounted.

The cut piece of foam 10 serves as an absorption layer and is formed from a foam material which is resilient in all spatial directions. On account of its use in a motor vehicle, it is necessary to provide a material whose resilience is ensured irrespective of the temperature. Therefore, soft polyurethane foam is particularly suitable for the use according to the invention.

One or more of the following determining variables should preferably be satisfied by the material to be selected for the foam part 10:
material density preferably 24 kg/m³ with a deviation of ±0.25;
compression hardness at 40% deformation: between 0.5 and 3 kPa, a range of 1.6 kPa ±0.25 being particularly advantageous;
foam material cell count between 20 and 200 per cm.

Satisfying the abovementioned compression hardness ensures that on the one hand the resilient deformability and on the other hand the force required for deformation are limited to a predetermined level.

The base material provided is preferably a polyether. The cut piece of foam 10 may also be formed entirely from polyether. However, a standard synthetic rubber material (TPE) is not suitable as material for the cut piece of foam 10, since this does not have the required resilience. Although a natural rubber is suitable for the use according to the invention, for most applications this material is ruled out by the relatively high price.

In a preferred embodiment of the sealing element 1, the cut piece of foam 10, at least in sections and in particular in a central region center part 11c, which is intended to bear against a corresponding bearing region or edge region 19 of the steering column cover 5, is covered by a covering part 20. The covering part 20 serves as a sliding layer with respect to the edge region 19 of the steering column cover 5 and is formed as a thin, flexible skin or layer which can stretch in all directions.

In addition, a Teflon layer may be provided at the region of the steering column cover 5 which is intended to bear against the sealing element 1. The steering column cover may also be formed from Teflon in this region.

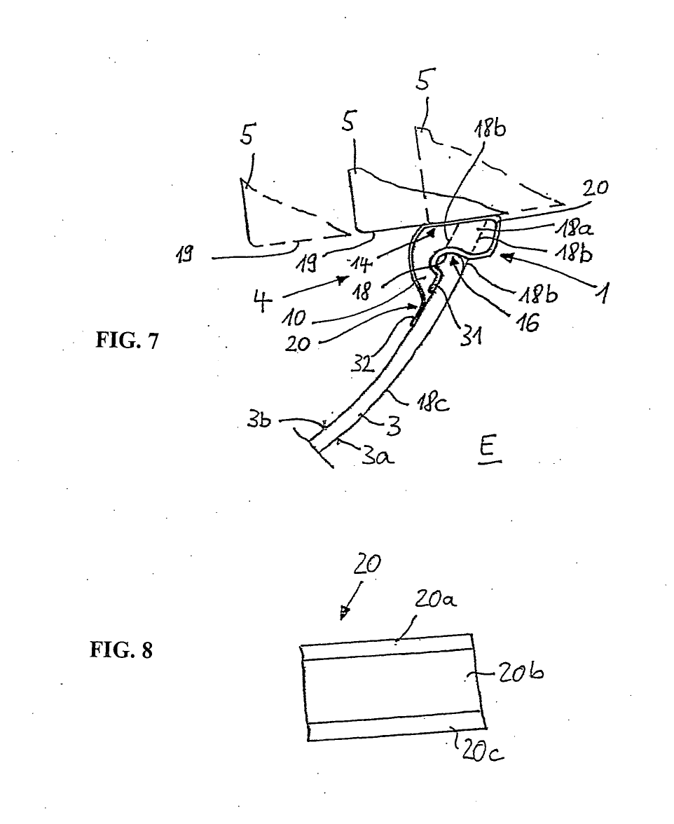

The sealing element 1, or if the arrangement of the covering part 20 is notionally ignored, the cut piece of foam 10 has, in accordance with the cross-sectional shape 13 thereof, a first bearing surface or bearing contour 14 (FIGS. 3 and 7) which is intended to press against a corresponding surface 19 of the steering column cover 5. For most applications, the bearing surface 14, on the corresponding side of the sealing element 1 or the cut piece of foam 10, extends at least over a central region 11c and preferably at least over a third of the longitudinal extent thereof. However, the size of the bearing surface 14 depends on the particular application and is located at a first region 15 of the sealing element 1 or of the cut piece of foam 10 and, given a curved configuration thereof, at an inner region 15, for example in the region spanned by the limbs 11a, 11b. Furthermore, the sealing element 1 or the cut piece of foam 10 or its cross-sectional shape 13, in the center part 11c, has a second bearing surface or bearing contour 16, which is located in a second or outer region 17 which is adjacent or opposite to the first region 16, of the cut piece of foam 10 and is intended to press against a corresponding edge region 18 of the lining part 3, or more specifically its opening 4.

The sealing element 1 comprising a cut piece of foam 10 and the layer with sliding properties, which may in particular be a covering part 20, is positioned in such a manner between the relevant lining part and the steering column cover that it is located stably between them. As seen with respect to a section plane E, in which the steering center axis LR lies and which in the embodiment illustrated runs through the middle third of the sealing element 1, the sealing element 1 is positioned in such a manner with respect to the steering column cover 5 and the lining part 3 that the extension 18a, projected onto the section plane, of the contour lines 18b of the edge region 18 of the lining part 3 or of the section lines of the lining part 3 in the section plane E is located inside the cross section of the sealing element 1.

In particular in the case of a configuration of the sealing element 1 which is curved in its longitudinal direction, it is preferable for the extension 18a, projected onto the section plane, of the contour lines 18b of the edge region 18 of the lining part 3 to lie inside the cross section of the sealing element 1.

In particular in the case of a less curved or substantially rectilinear configuration of the sealing element 1, it is preferable for the extension 18a, projected onto the section plane, of the contour lines 18c of the edge region 18 of the lining part 3 in the section plane E to lie inside the cross section of the sealing element 1.

The stable position of the sealing element 1 is required in particular in the case of an adjustable steering column, on account of the relative movements between the steering column cover 5 and the lining part 3 which occur during the adjustment of the steering column.

The sealing element 1 or the cut piece of foam 10 may in this case, as seen in the section plane E in which the steering shaft is located, be formed in such a manner that in the undeformed state of the sealing element 1 or the cut piece of foam 10, the first bearing surface 14 of the latter has a larger extent as seen transversely to the longitudinal direction of the cut piece of foam than the second bearing surface 16 thereof. In most applications, this improves the stability of the position between the lining part and the steering column cover.

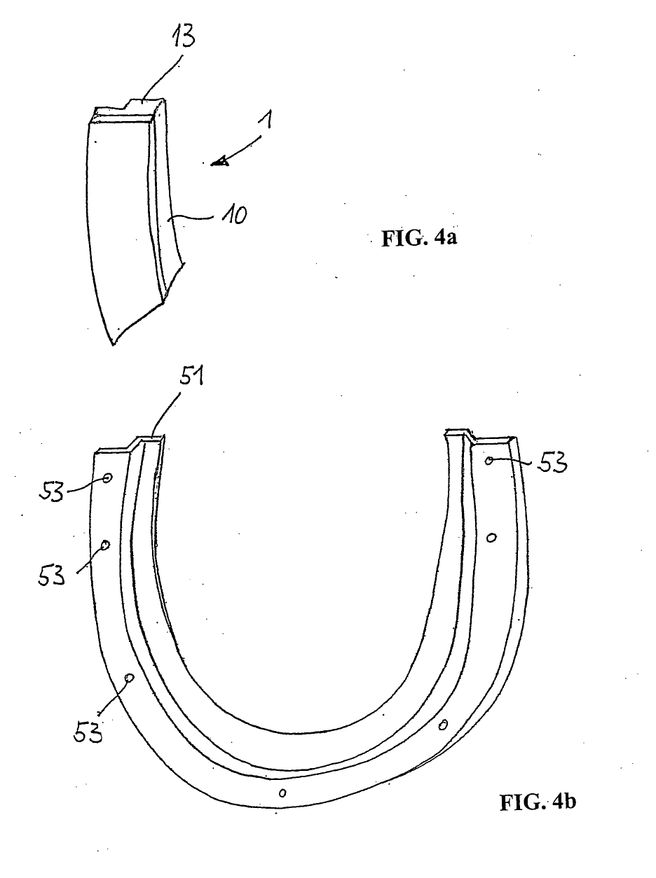

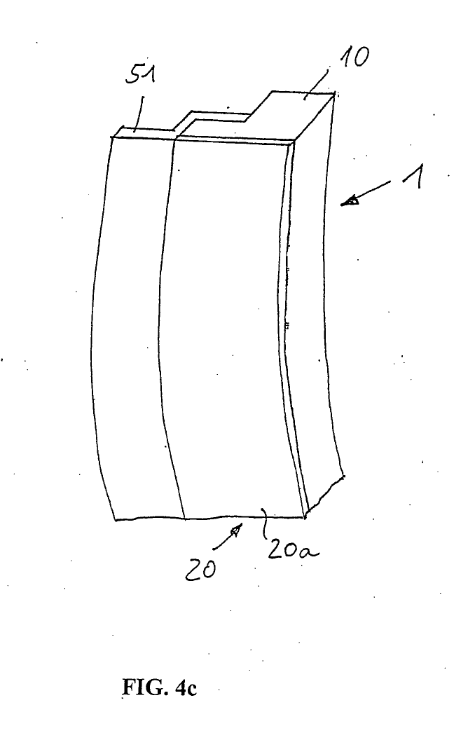

In a first alternative according to the invention, the sliding layer, at least in sections, can be laminated or adhesively bonded onto the first bearing surface 14 of the cut piece of foam 10 or applied to it in some other way, in particular by flocking (FIGS. 4a, 4c). In this case, the cut piece of foam 10, together with the sliding layer 20a arranged at least in regions, can be fitted, via a frame element 51, on the corresponding edge region 18 of the lining part 3 or directly on the latter, preferably by welding or adhesive bonding.

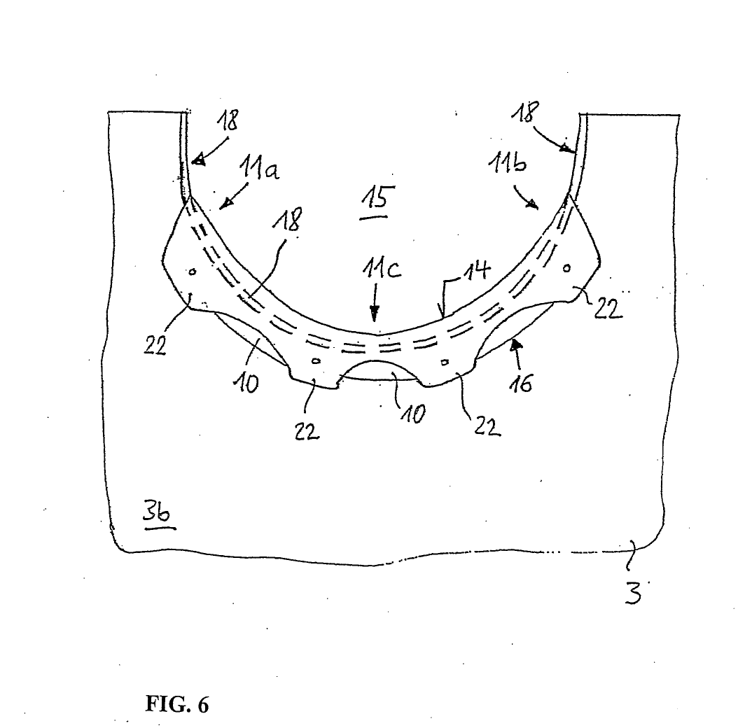

In a second alternative according to the invention, the cut piece of foam 10 can be formed with a sliding layer in the form of a covering part 20, which at least in sections covers or is stretched over the cut piece of foam (FIGS. 6, 7 and 9a to 9d).

In a third alternative according to the invention, the covering part 20 may be formed as a flexible tube or hose in the shape of the sealing element 1 that is to be produced, into which flexible tube or hose foam is foamed in order to produce the foam part 10 and therefore the entire sealing element 1 (not illustrated).

In the second and third alternatives, it is also possible to use a cut piece of foam 10 in accordance with the first alternative, to which, therefore, a layer with sliding properties is applied at least in sections.

In all the alternatives mentioned, the cut piece of foam 10, with or without a layer with sliding properties or covering part 20, can be fitted on a frame element 51 (FIGS. 4a, 4b, 4c), which for its part is attached to the lining part, for example by means of securing means. The illustration presented in FIG. 4b shows bores 53 for realizing this form of securing. Of course, it is also possible for the frame part 51 or the combination 55 (FIG. 4c) of frame part 51 and cut piece of foam 10 with covering part 20 to be adhesively bonded onto or welded to the lining part. In detail, FIG. 4b shows the frame part 51 for receiving the cut piece of foam 10 according to the invention. The frame part 51 may be formed integrally with the lining part 3 or as an independent part which is to be arranged on the lining part 3.

In the alternatives mentioned, the covering part 20 may be in the form of one, two, three or in general terms more layers. In any event, the outer side, facing the steering column cover 5, of the covering part 20 is formed from a material with sliding properties, preferably from a polyamide fabric. The provision of two or generally more layers results in increased stability of the material and in the formation of creases at the sliding surfaces being minimized. On the other hand, an increase in the thickness of the material of the covering part 20 leads to a reduction in the flexibility which likewise needs to be achieved. Therefore, it is preferable to provide for the covering part 20 to be in the form of one, two or three layers.

If the covering part is in single layer form, it is formed from a fabric with sliding properties, preferably from a polyamide fabric.

If the covering part 20 is formed from two layers, on its outer side, i.e. on the side which faces the corresponding edge region 19 of the steering column cover 5, it is formed from a fabric with sliding properties, preferably from a polyamide fabric, while the covering part on the side of the cut piece of foam has a foam layer.

A three-layer configuration of the covering part 20 is illustrated in FIG. 8. In this case, the covering part 20 is formed from two stretchable fabric layers 20a, 20c with sliding properties on the outer side and the inner side, and preferably a polyamide fabric and a further foam layer 20b located between them. In the present context, the outer side is once again to be understood as meaning the side which faces the corresponding edge region of the steering column cover, while the inner side is once again to be understood as meaning the side of the cut piece of foam.

In all variants, it is preferable for a polyamide fabric to be provided on the outer side of the covering part 20. In conjunction with the arrangement of the cut piece of foam 10 in accordance with the invention at the corresponding edge region of the lining part 3 and the shaping of the cut piece of foam 10 or the sealing element 1, the result is that even in the event of a movement of the steering column cover 5, the sealing element 1 adopts a stable position, ensuring that the interior IR is sealed off.

Corresponding stamped parts can be used as starting material for the fabric with sliding properties and also for the entire covering part 20. If a foam layer is used for the covering part 20, this layer is preferably foamed on. It can therefore be foamed directly onto the cut piece of foam 10 if the covering part 20, at least in regions, is applied direct to the cut piece of foam 10. If a two-layer or three-layer covering part, which is intended to be stretched across the cut piece of foam 10, is used, the foam layer can be foamed onto a fabric with sliding properties.

Alternatively, the covering part 20 can also be adhesively bonded onto the cut piece of foam 10. In this case, strips or a mesh of adhesive tracks are used, so that it is possible to compensate for the distortion in the covering part 20 with respect to the cut piece of foam 10 caused by relative movements.

In the second alternative mentioned, in which the covering part 20 is stretched over the foam part 10, a first edge 31 of the covering part 20 is fixed on the corresponding edge region 18 of the lining part 3. A second edge 32, on the opposite side from the first edge, is likewise fixed to the lining part 3. The first edge 31 and the second edge 32 are preferably fixed to the same side of the covering part 20, specifically the chassis side 3b. In this case, the covering part 20 stretches around the foam part 10 at least in regions. The fixing of the first edge 31 and/or the second edge 32 of the covering part 20 can be effected by means of securing means or by welding or adhesive bonding or combinations thereof. In addition, the foam part can be applied or fixed to the corresponding region of the lining part 3 by these means. In this case, the foam part can be fitted onto the lining part 3 by means of a frame element 51.

The fixing of the first edge 31 of the covering part can take place together with fixing of the foam part to the lining part 3 or to the covering part 20.

The fixing of the covering part at its edges is diagrammatically depicted in FIG. 6. This can take place in regions or in punctiform fashion by welding, adhesive bonding or by mechanical means. In the case of adhesive bonding, it must in particular be ensured that the adhesive bond which is formed is strong enough to withstand the stretching movements which occur during operational use.

Therefore, the edge 32 of the covering part 20 on the opposite side from the first edge 31 is pulled over the cut piece of foam 10 and therefore extends over the entire side 14, facing the steering column cover, of the cut piece of foam 10, and is secured to the lining part on the opposite surface 14.

On the second edge side 32, which is pulled over the cut piece of foam 10 and is secured to the second side 3b of the lining part 3, the covering part 20 has clips 22 which are separated from one another by cutouts 23. This allows crease-free securing of the covering part to the second side 3b of the lining part 3. The covering part at least partially surrounds the cut piece of foam on the surfaces facing the steering column cover.

The welding can in general be effected by means of ultrasound processes.

In the case of the first edge 31 and/or the second edge 32 being secured by mechanical means, openings 41 are provided in the clips 22, interacting with corresponding securing domes or hooks or other securing means 40 arranged on the lining part 3, so that the clips can be fixed in a position in which they are stretched over the foam part 10.

In addition, further sound insulation material, e.g. felt, may be applied to the lining part 3 in order to achieve additional sound insulation.

As an alternative, the variants described for the arrangement of the sealing element on the lining part 3 can also be provided for the arrangement of the sealing element 1 on the steering column cover. This is useful in particular if the steering column is not longitudinally displaceable, but rather only vertically displaceable.

The text which follows describes the process according to the invention for mounting the sealing element 1 on an inner lining part of a motor vehicle.

In a first step, the lining part is positioned on the top side 101 of a receiving apparatus 100, which is itself in turn usually arranged on a mounting device 102. The receiving apparatus 101 is preferably in a form which is such that on receiving the lining part 3 the top side 102 of the receiving apparatus 101 in regions interacts in a positively locking manner with the interior side 3a of the lining part 3. The lining part 3 can additionally be fixed to the receiving apparatus by securing means or secured to it to execute the mounting of the sealing element 1. As can be seen from FIG. 8a, the lining part 3 preferably rests on the receiving apparatus 101 in such a manner that the opposite side from the interior side 3a is located so as to be freely accessible for mounting. In this case, the orientation of the receiving apparatus 101 and/or the lining part 3 after it has been placed on the receiving apparatus 101 can be oriented according to the boundary conditions for mounting. For example, the mounting device may be a mounting plate which extends in the horizontal plane, so that the lining part 3, on account of its usually curved surface structure, is positioned substantially obliquely with respect to the horizontal plane.

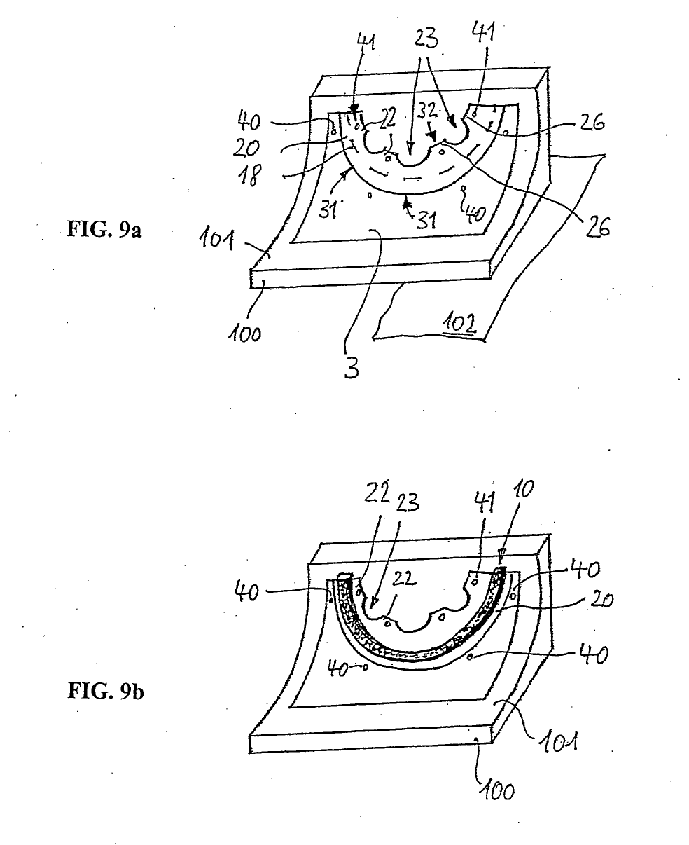

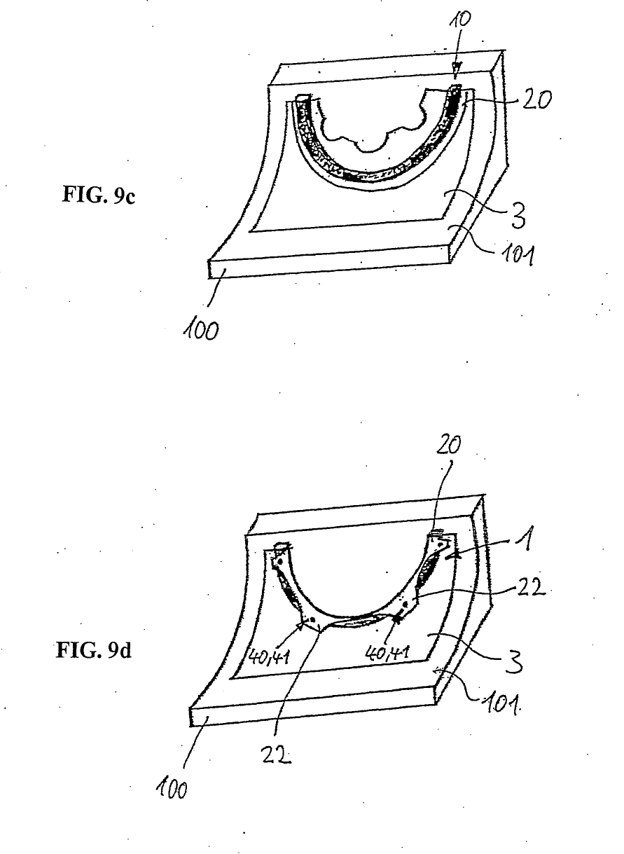

Furthermore, a prefabricated starting material of the covering part 20 is applied to the lining part 3. The covering part 20 can be put in place by means of a template. FIG. 9a shows the lining part fitted on the receiving apparatus 101, with the covering part 20 fixed to it, in the prefabricated state. The lining part is fixed by means of a first edge region 31 on the lining part 3. This can be realized in various ways. Preference may be given to welding or adhesive bonding, in which case this operation may take place in punctiform fashion or over linear or areal regions of the edge region 31. In the case of adhesive bonding, it is necessary in particular to ensure that the adhesive bond which forms is sufficiently strong to withstand the stretching movements which occur during operational use. The edge region can also be suspended by means of prefabricated openings or slots at securing domes or hooks or similar securing means which are provided on the wide side 3b of the lining part 3.

The second edge region 32 of the prefabricated covering part 3 has clips 22 which are separated from one another by cutouts 24. This configuration of the second edge region 32 effects crease-free securing of this second edge region 26 to the lining part 3 after the further mounting steps have been carried out. After the securing of the first edge region 25 to the lining part, the clips 22 form a free edge side of the prefabricated covering part (FIG. 9a).

In a further step of mounting the sealing element on the lining part 3, the cut piece of foam is placed onto the lining part (FIG. 9b). The cut piece of foam or the sealing element 1, interacting with the steering column cover, is arranged on the lining part 3 in such a manner that parts of the sealing element 1 extend on both sides of the extension of the cross section of the lining part 3. To achieve this arrangement, it is preferable to use an auxiliary apparatus, such as for example a template (not illustrated).

Furthermore, the cut piece of foam is fixed or secured at predetermined points on the chassis side 3b of the lining part (FIG. 9c). The securing of the cut piece of foam 10 can be carried out in various ways. Firstly, the cut piece of foam 10 can be secured to the covering part 20 or to the lining part 3. Moreover, it can be secured both to the covering part 20 and to the lining part 3.

The form of securing may once again preferably involve welding, specifically in punctiform fashion. FIG. 9c illustrates this alternative by means of diagrammatically indicated weld spots 110. Welding can also be effected via linear joining locations or regional joining locations. In addition to welding, in general adhesive bonding is also considered, in accordance with the alternatives described, and so too is a mechanical form of securing. The mechanical securing may once again be effected by means of securing domes or hooks (not illustrated) provided on the lining part 3. These forms of securing or securing means may also be combined with one another.

In a further step, the clips 22 of the covering part 3 are pulled over the cut piece of foam 10 to such an extent that they can be secured at locations provided for this purpose.

In a first alternative, to this end the cut piece of foam is welded to the chassis side 3b of the lining part 3 at predetermined points or regions (FIG. 9d). In a second alternative, openings or slots provided at the clips 22 are suspended at corresponding securing means, such as for example hooks or domes, provided on the chassis side 3b of the lining part 3.

The mounting process described is also suitable for the situation in which the foam part 10 is produced by foam material being introduced into a flexible tube or sleeve or hose.

1. A sealing element to be arranged between a lining part and a steering column cover of a steering shaft, wherein the foam part is formed from a resilient material and with two limbs and a curved center part connecting them, or in a form which is continuous in the peripheral direction.

2. (canceled)

3. The sealing element to be arranged between a lining part and a steering column cover of a steering shaft as claimed in claim 1, wherein the sealing element is formed in two layers from the resilient foam part and in addition, on the side facing the steering column cover, at least in sections additionally from a layer of material with sliding properties.

4. The sealing element to be arranged between a lining part and a steering column cover of a steering shaft as claimed in claim 3, wherein the layer of material with sliding properties is laminated on, adhesively bonded on or applied to the foam part by flocking.

5. The sealing element to be arranged between a lining part and a steering column cover of a steering shaft as claimed in claim 3, wherein the layer of material with sliding properties is formed from a covering part made from flexible and stretchable material.

6. The sealing element as claimed in claim 5, wherein the covering part, at least in sections, is stretched over the foam part.

7. The sealing element as claimed in claim 5, wherein the covering part is fixed on the lining part by means of securing means.

8. The sealing element as claimed in claim 5, wherein the covering part is adhesively bonded to the lining part in punctiform fashion or in regions.

9. The sealing element as claimed in claim 5, wherein the covering part is welded to the lining part in punctiform fashion or in regions.

10. The sealing element as claimed in claim 5, wherein the covering part is formed as a flexible tube or hose in the shape of the sealing element to be produced, into which flexible tube or hose foam is foamed.

11. The sealing element as claimed in claim 5, wherein the covering part is formed in a single layer from a polyamide fabric.

12. The sealing element as claimed in claim 5, wherein the covering part is formed in two layers from a polyamide fabric and a foam layer, the foam layer being arranged on the side of the foam part.

13. The sealing element as claimed in claim 5, wherein the covering part is formed in three layers from two polyamide fabric layers and a foam layer positioned between them.

14. The sealing element as claimed in claim 5, wherein one or more of the following determining variables are satisfied by the material of the foam part:
material density preferably 24 kg/m³ with a deviation of ±0.25;
compression hardness at 40% deformation: between 0.5 and 3 kPa;
foam material cell count between 20 and 200 per cm.

15. The sealing element as claimed in claim 1, wherein the foam part is formed from polyether or polyurethane.

16. An arrangement between a lining part and a steering column cover having a sealing element arranged between them, wherein the sealing element, as seen in a section plane in which the steering center axis lies and which passes through the middle third of the sealing element, is positioned in such a manner with respect to the sealing column cover and the lining part that the extension, projected onto the section plane, of the contour lines of the edge region of the lining part or of the section lines in the section plane lies inside the cross section of the sealing element.

17. The arrangement comprising a sealing element as claimed in claim 16, wherein the sealing element is fitted on a frame element.

18. The arrangement between a lining part and a steering column cover with a sealing element arranged between them as claimed in claim 16, wherein a Teflon layer is arranged on the region of the steering column cover which is intended to bear against the sealing element.

19. A method for mounting a sealing element between a lining part and a steering column cover, comprising the following steps:
positioning the lining part on the top side of a receiving apparatus,
placing a prefabricated starting material on the lining part to form the covering part,
fixing the covering part to the lining part by way of a first edge region,
fixing a second edge region of the prefabricated covering part to the lining part by means of clips.

20. The method for mounting a sealing element as claimed in claim 19, wherein the fixing of the covering part by way of a first edge region is effected by adhesive bonding or welding or by means of securing elements.

21. The method for mounting a sealing element as claimed in claim 19, wherein the fixing of the covering part by way of the second edge region is effected by adhesive bonding or welding or by means of securing elements.

22. The method for mounting a sealing element as claimed in claim 19, wherein the foam part is secured to the covering part and/or to the lining part.

23. The method for mounting a sealing element as claimed in claim 19, wherein the welding or adhesive bonding is effected in punctiform fashion or over areal regions.
